(19) United States
(12) Patent Application Publication
(10) Pub. No.: US 2025/0207293 A1
(43) Pub. Date: Jun. 26, 2025

(54) ELECTROLYTE MEDIUM AND METHOD FOR ELECTROCHEMICAL POLISHING OF METAL WORKPIECES USING SUCH AN ELECTROLYTE MEDIUM

(71) Applicant: OTEC Praezisionsfinish GmbH, Straubenhardt-Conweiler (DE)

(72) Inventors: Carlos Barbado FERNANDEZ, Pforzheim (DE); Luca WOELK, Keltern (DE); Lukas GOEHLER, Remchingen (DE); Maximilian ECKL, Pforzheim (DE); Nico GEGENHEIMER, Ettlingen (DE); Melina WINGERATH, Keltern (DE)

(73) Assignee: OTEC Praezisionsfinish GmbH, Straubenhardt-Conweiler (DE)

(21) Appl. No.: 19/077,754

(22) Filed: Mar. 12, 2025

Related U.S. Application Data
(63) Continuation of application No. PCT/EP2023/072755, filed on Aug. 18, 2023.

(30) Foreign Application Priority Data
Sep. 12, 2022 (DE) 10 2022 123 211.5

(51) Int. Cl. C25F 3/16; B24B 37/04

(52) U.S. Cl. CPC C25F 3/16; B24B 37/046

(57) ABSTRACT

An electrolyte medium for electrochemical polishing of metal workpieces, which contains a plurality of solid granulate particles and a liquid electrolyte. The liquid electrolyte comprises an emulsion with a continuous phase of at least one electrically conductive hydrophilic liquid and, emulsified herein, a disperse phase of at least one hydrophobic liquid which is immiscible with the electrically conductive hydrophilic liquid and is less electrically conductive by comparison. A method provides for electrochemical polishing of metal workpieces, wherein an electrolyte medium of the aforementioned kind is added to a container and electrically conductively connected to a cathode, the metal workpiece being electrically conductively connected to an anode and being dipped into the electrolyte medium located in the container, the electrodes being acted on by an electrical voltage and the workpiece being moved relative to the plurality of solid granulate particles of the electrolyte medium.

This nonprovisional application is a continuation of International Application No. PCT/EP2023/072755, which was filed on Aug. 18, 2023, and which claims priority to German Patent Application No. 10 2022 123 211.5, which was filed in Germany on Sep. 12, 2022, and which are both herein incorporated by reference.

### BACKGROUND OF THE INVENTION

### Field of the Invention

The invention relates to an electrolyte medium for the electrochemical polishing of metal workpieces which contains a plurality of solid granulate particles and a liquid electrolyte. The invention further relates to a method for electrochemical polishing of metal workpieces, such an electrolyte medium being added to a container and being electrically conductively connected to a cathode, the metal workpiece being electrically conductively connected to an anode and immersed in the electrolyte medium located in the container, the electrodes being subjected to an electrical voltage and the workpiece being moved relative to the plurality of solid granulate particles of the electrolyte medium.

### Description of the Background Art

For the surface treatment of workpieces, what are referred to as drag finishing methods are known in which the workpiece is immersed in a bed of solid grinding or polishing granulate particles located in a container and is moved relative to said bed of granulate particles. Drag finishing machines are usually used here, which are a special form of vibratory grinding machines in which the workpieces to be processed are releasably fixed, for example individually or to one or more clamping devices of a workpiece holder of the machine, in order to polish or grind them as a result of the relative movement in relation to the bed of granulate particles. Such drag finishing machines often comprise a generally rotating part, essentially in the form of a plate that is rotatably driven by a motor via a suitable gear, for example, to which the workpiece holders are fixed directly or indirectly, for example via lifting devices. This takes place in particular eccentrically with respect to the axis of rotation of the rotating part of the drag finishing machine. If this part-known as the plate-of the drag finishing machine is rotated, the workpiece holders attached thereto thus describe a trajectory. In this case, the workpieces carried by the clamping devices of the workpiece holders are immersed in the container, which is filled with the bed of granulate particles, often with the addition of liquid processing media such as water, surfactants, etc., whereby due to the relative movement of the workpieces in relation to the granulate, the surface treatment thereof takes place in the form of vibratory grinding.

Drag finishing machines are known, for example, from DE 102 04 267 C1, DE 200 05 361 U1 or DE 10 2010 052 222 A1, which are herein incorporated by reference.

Alternatively or additionally, the container receiving the granulate particles can be moved relative to the workpieces which are also moving, for example rotating at least about their own axis, or even at rest, such as about its own axis and/or along a trajectory, e.g., in the form of a circular path. If only the container is moved and the workpieces themselves do not perform any translational movement, this is also referred to as “plunge grinding” or “plunge polishing” as a special form of drag finishing, such machines in which the workpiece holder carrying the workpiece during its surface treatment is essentially stationary also being referred to as plunge finishing machines.

Depending on the workpieces to be treated, the granulate particles can essentially be of various natures and, for example, of natural origin (e.g., from organic material such as walnut or coconut shells, wood, cherry stones, etc.), mineral origin (e.g., from silicates, oxides, etc.) and/or synthetic origin (e.g., from plastics). In addition, as already mentioned, it is known to carry out the vibratory grinding process dry or-with the addition of a liquid processing medium, such as water, which can be mixed with additives such as surfactants—in the form of wet processing.

In order to ensure a rotational movement of the workpieces, such as about their own axis, as an alternative or in addition to a translational movement of the workpieces relative to the granulate particles, which leads to an even more effective surface treatment, the workpiece holders of known drag finishing machines are often rotatably driven, which can be done, for example, by means of suitable motors (see, for example, DE 10 2010 052 222 A1). In addition, workpiece holders for drag finishing machines are known whose clamping devices for the releasable fastening of the workpieces are rotatably mounted and can be set in rotation via a shaft rotatably mounted in the workpiece holder. For this purpose, the workpiece holder has, for example, a planetary gear with a central sun gear, which is in engagement with planetary gears, which in turn are connected in a rotationally fixed manner to a support shaft of a corresponding clamping lock and are arranged distributed around the periphery of the sun gear of the workpiece holder. Due to such a movement of the clamping devices rotatably mounted on the workpiece holder with the workpieces, which is made up of a translational movement (in the direction of rotation of the support part or the “plate” of the drag finishing machine) and a rotational movement (about the axis of the corresponding clamping device or about the workpiece axis) through the processing medium, a uniform processing quality is achieved with shorter processing times compared to a purely translational movement. Furthermore, alternatively or additionally, the workpiece holder itself can be fixed in a correspondingly rotatable manner to the support part of the drag finishing machine (see, for example, DE 20 2009 008 070 U1, which is incorporated herein by reference).

In addition, conventional drag finishing methods for polishing or grinding metal workpieces of the aforementioned type have been further developed into electrochemical polishing methods in that, on the one hand, the metal workpiece is electrically connected to a positive electrode (anode) and, on the other hand, the granulate particles flooded with a liquid electrolyte are electrically connected to a negative electrode (cathode), the electrodes being subjected to an electrical voltage and the workpiece being moved relative to the plurality of solid granulate particles, e.g., in the manner described above. The surface quality of the machined workpieces can often be improved in this way, such electrochemical polishing also representing a method of abrasive surface treatment. If the electrodes are subjected to an electrical voltage by means of a voltage source, then, in addition to the purely mechanical surface treatment of the metal workpieces, a current flow occurs due to the electrical conductivity of the liquid electrolyte, which ensures the surface, anodic removal of the metal workpieces. In this case, the electrodes can be supplied either with DC voltage or with pulsed voltages. Typically, the workpieces are moved in the electrolyte solution in order to ensure the desired relative movement of said solution relative to the solid granulate particles and to keep the concentration gradient that forms on the surface of the workpieces as low as possible. The selection of a suitable liquid electrolyte is an important parameter here, and it has been shown that some electrolytes which lead to perfect electropolishing on one metal have practically no effect on another metal or result in a rough, jagged or matte surface. For example, strong inorganic acids, particularly phosphoric acid and sulfuric acid, which may be mixed with alcohols, are traditionally used for electropolishing aluminum and steel. For copper and brass, for example a mixture of phosphoric acid and alcohols is suitable.

WO 2007/121999 A2 describes a liquid electrolyte in the form of an electrolyte solution intended for electropolishing metal workpieces, and a method for electrochemically polishing workpieces using such a liquid electrolyte solution, the electrolyte solution containing alkylbenzenesulfonic acid or alkylbenzenesulfonates, i.e., the salts or derivatives thereof, a petroleum fraction with 17 to 35 carbon atoms, and optionally small amounts of ethanolamine. EP 2 646 603 B1, which is incorporated herein by reference, discloses an improved liquid electrolyte solution for electrochemical polishing of metal workpieces, in particular made of copper, zinc, silver, tin, gold or the alloys thereof, as well as a method for electrochemical polishing using such an electrolyte solution, which contains ethoxylated alcohols, sulfonic acids and/or sulfonates, inorganic acids and liquid hydrocarbons, as well as water.

In addition, electrolyte media have recently been proposed for the electrochemical polishing of metal workpieces, which on the one hand comprise a plurality of solid, porous polymer-based granulate particles and on the other hand comprise a liquid electrolyte made of an electrically conductive, hydrophilic liquid, in particular from the group of strong inorganic acids and sulfonic acids, the liquid electrolyte being, however, exclusively absorbed in the pores of the granulate particles and a gas or air atmosphere being otherwise present in the cavity volume of the granulate particles (cf. e.g., WO 2017/186992 A1 (which corresponds to US 2018/0298518), WO 2019/145588 A1 (which corresponds to US 2020/0270763), WO 2020/099699 A1 (which corresponds to US 2021/0262112), WO 2020/174112 A1, WO 2020/099700 A1 (which corresponds to US 2021/0122941) or WO 2021/156530 A1 (which corresponds to US 2022/0364256). However, due to the current flow being induced only at specific points as a result of contact between a particular granulate particle and the workpiece to be processed, surface processing of the workpieces in this way is very time-consuming.

ES 2 904 576 A1, which corresponds to US 2024/271315, describes another electrolyte medium for the electrochemical polishing of metal workpieces, which also comprises on the one hand a plurality of solid porous polymer-based granulate particles and on the other hand a liquid electrolyte based on water, which is absorbed in the pores of the granulate particles. In this case, instead of a gas atmosphere present in the cavity volume of the granulate particles, a non-electrically conductive liquid, e.g., based on silicones or hydrocarbons, which is immiscible with the aqueous electrolyte, is provided. With regard to the disadvantages, the above-mentioned comments on the gas atmosphere in the cavity volume of the granulate particles apply, the preparation of the electrolyte medium also proving to be complex. A similar electrolyte medium for the electrochemical polishing of metal workpieces can be found in WO 2022/123096 A1, which corresponds to US 2024/0102197, which in turn comprises, on the one hand, a plurality of solid, porous, polymer-based granulate particles and, on the other hand, a liquid electrolyte based on water or diluted acids which is absorbed in the pores of the granulate particles. The non-electrically conductive liquid, e.g., based on silicones or hydrocarbons, which is immiscible with the aqueous electrolyte, in the cavity volume of the granulate particles can in this case be either homogeneous or formed as a continuous phase of a “water-in-oil emulsion” in which droplets of the aqueous electrolyte are emulsified as a disperse phase.

### DETAILED DESCRIPTION

It is therefore an object of the invention to provide an electrolyte medium for the electrochemical polishing of metal workpieces of the type mentioned at the outset, in a simple and cost-effective manner, while at least largely avoiding the aforementioned disadvantages, in such a way that the surface processing time is reduced and the efficiency of the electropolishing is improved in this way while ensuring a perfect surface quality of the electropolished workpieces and avoiding even local corrosion thereof. It is further directed to a method for the electrochemical polishing of metal workpieces of the type mentioned at the outset using such an electrolyte medium.

The first part of this object is achieved according to the invention—in the case of an electrolyte medium for the electrochemical polishing of metal workpieces which contains a plurality of solid granulate particles and a liquid electrolyte—in that the liquid electrolyte has an emulsion with a continuous phase of at least one electrically conductive, hydrophilic liquid and a disperse phase emulsified therein of at least one hydrophobic liquid which is immiscible with the electrically conductive, hydrophilic liquid and, in contrast, is less electrically conductive.

In terms of process engineering, the invention further provides a method for electrochemical polishing of metal workpieces to solve this problem, an electrolyte medium of the aforementioned type being added to a container and electrically conductively connected to a cathode, the metal workpiece being electrically conductively connected to an anode and immersed in the electrolyte medium located in the container, the electrodes being subjected to an electrical voltage and the workpiece being moved relative to the plurality of solid granulate particles of the electrolyte medium.

The liquid electrolyte of the electrolyte medium according to the invention is therefore formed from an “oil-in-water emulsion”, the—polar—continuous phase of which includes at least one electrically conductive, hydrophilic (lipophobic) liquid and represents the actual electrolyte, which serves to produce an electrical current flow between the anode (positive electrode) connected to the metal workpiece and the cathode (negative electrode) connected to the electrolyte medium. In this way, due to a relatively high electrical conductivity of the electrolyte medium, an effective and time-efficient surface treatment of the metal workpieces with high surface quality and a relatively low energy consumption is possible, since the electrically conductive, hydrophilic liquid present in the cavity volume of the solid granulate particles as a—polar—continuous phase of the liquid electrolyte—in this respect similar to the case of an electrolyte solution-always ensures an electrically conductive connection between the workpiece to be processed, which is usually in contact with the anode, and the cathode. The—non-polar—disperse phase emulsified in the aforementioned continuous phase, formed of at least one hydrophobic (lipophilic) liquid that is immiscible with the electrically conductive, hydrophilic liquid and is less electrically conductive, and which in particular can also be essentially non-electrically conductive, serves on the one hand to effectively protect the metal workpieces from even local corrosion during electrochemical surface treatment, the less electrically conductive or non-electrically conductive, hydrophobic liquid being able to be easily deposited on the surface of the workpieces being treated due to its finely dispersed distribution in the electrically conductive, hydrophilic liquid of the continuous phase during surface treatment and being able to develop an anti-corrosive protective effect. On the other hand, the less electrically conductive or non-electrically conductive hydrophobic liquid of the disperse phase can ensure adjustment of the electrical conductivity and the pH of the electrolyte medium according to the invention by varying its proportion.

Compared to conventional electrolyte media, which contain hydrophilic, electrically conductive liquids on the one hand and hydrophobic, electrically non-conductive or less conductive liquids on the other hand, but as a single-phase solution, as is the case, for example, with WO 2007/121999 A2 or EP 2 646 603 B1 mentioned at the outset, the electrolyte medium according to the invention has the advantage that it can be used for surface treatment of workpieces made of practically any electrically conductive metal material, the less electrically conductive or non-electrically conductive, hydrophobic liquid of the disperse phase being able to offer the workpieces more effective corrosion protection, while the electrically conductive, hydrophilic liquid of the continuous phase can have a high electrical conductivity and consequently ensures efficient surface treatment. Compared to an electrolyte medium in which the electrically conductive hydrophilic liquid as the actual electrolyte is absorbed exclusively in the pores of the porous granulate particles and the cavity volume between the granulate particles is filled with an electrically non-conductive hydrophilic liquid that is immiscible therewith (cf. the above-cited ES 2 904 576 A1) or with a “water-in-oil emulsion” of the electrically conductive hydrophilic liquid as a disperse phase in the electrically non-conductive hydrophilic liquid that is immiscible therewith as a continuous phase (cf. the above-cited WO 2022/123096 A1), the electrolyte medium according to the invention offers the advantage that, in addition to being easier to manufacture in terms of handling, it ensures a significantly shorter processing time with lower energy requirements, since the electrically conductive hydrophilic liquid in the continuous phase ensures lower electrical resistance.

Furthermore, it should be noted at this point that the term “electrochemical polishing” in the sense of the present invention can include electrochemical smoothing as well as electrochemical brightening.

The average droplet size of the hydrophobic liquid of the disperse phase of the emulsion of the liquid electrolyte can be adjusted within wide limits, in particular by the type and amount of suitable emulsifiers (see below), i.e., the emulsion can basically be a macroemulsion with an average droplet size of greater than about 1 μm up to about 1 mm, a microemulsion with an average droplet size of less than about 1 μm, or a nanoemulsion with an average droplet size of less than about 100 nm. The emulsion of the liquid electrolyte, which does not necessarily have to be substantially monodisperse, can be produced in a manner known per se, for example by introducing shear forces into the inhomogeneous mixture, e.g., by means of known rotor-stator systems, high-pressure emulsifiers or the like, by dispersing the inhomogeneous mixture using microporous membranes, etc.

The electrically conductive, hydrophilic liquid of the continuous phase of the emulsion of the liquid electrolyte can preferably contain at least one liquid from the group of polar organic solvents, in particular from the group of alcohols, and/or water. Examples of advantageous alcohols include monohydric alcohols, such as phenoxyethanol, and in particular di- or polyhydric alcohols, such as glycols, in particular ethylene glycol, 1,2-propylene glycol, 1,3-propylene glycol, propane-1,2,3-triol (glycerol) and the like, including mixtures thereof.

In order to adjust the electrical conductivity and the pH, the electrically conductive, hydrophilic liquid of the continuous phase of the liquid electrolyte emulsion preferably further contains at least one acid. Examples of advantageous acids include both inorganic acids, such as sulfuric acid (H₂SO₄), sulfurous acid (H₂SO₄), hydrochloric acid (HCl), hydrofluoric acid (HF), phosphoric acid (H₃PO₄), nitric acid (HNO₃), nitrous acid (HNO₂) and the like, as well as organic acids such as oxalic acid (C₂H₂O₄), citric acid (C₆H₈O₇), sulfonic acids, preferably methanesulfonic acid (CH₄O₃S), ethanesulfonic acid (C₂H₆O₃S), benzenesulfonic acid (C₆H₆O₃S) including the sulfonates thereof, and the like, including mixtures thereof.

The hydrophobic liquid of the disperse phase of the emulsion of the liquid electrolyte can preferably contain at least one liquid from the group of, in particular aliphatic, hydrocarbons and/or silicone oils. Examples of advantageous hydrocarbons include those having 10 to 20 carbon atoms, preferably 12 to 16 carbon atoms, in particular in the form of alkanes including iso- and cycloalkanes and mixtures thereof. Examples of advantageous silicone oils include those having a viscosity between about 1 and about 2×10⁶ cSt, especially in the form of polydimethylsiloxanes.

In an example, it can be provided that the proportion of the disperse phase of the emulsion is between about 15% by mass and about 70% by mass, in particular between about 25% by mass and about 60% by mass, for example between about 30% by mass and about 60% by mass, based on the entire emulsion having both a continuous and disperse phase.

In order to ensure a stable emulsion of the liquid electrolyte and in particular to prevent coalescence of the emulsified droplets of the disperse phase of the non-electrically conductive or slightly electrically conductive hydrophobic liquid in the continuous phase, the emulsion expediently further contains at least one emulsifier, in particular from the group of surfactants as surface-active substances.

Examples of advantageous emulsifiers include those from the group of alkoxylated alcohols with at least 8 carbon atoms, in particular with at least 10 carbon atoms, such as ethoxylated iso-or n-tridecanol, secondary fatty alcohol ethoxylates (polyalkylene glycol ethers), (2-methoxymethylethoxy) propanol and the like, sulfonic acids with at least 8 carbon atoms, in particular with at least 10 carbon atoms, including the sulfonates thereof, such as alkylsulfonic acids and sulfonates, preferably decane-, undecane-, dodecane- and tridecanesulfonic acid, alkylbenzenesulfonate, cumenesulfonate, sodium and potassium sulfonates, preferably sodium p-cumenesulfonate, potassium p-cumenesulfonate etc., benzene-1,1-oxybis-tetrapropylene derivatives sulfonated (sodium salt) and the like, and alaninates, such as sodium N-(2-carboxyethyl)-N-(2-ethylhexyl)-beta-alaninate and the like.

The HLB value of the at least one emulsifier is advantageously between about 8 and about 18, in particular between about 9 and about 16. In this case, the above-mentioned amounts of the HLB value (hydrophilic-lipophilic balance) of the emulsifier, particularly in the form of surfactants, refer to the Griffin calculation method, according to which the HLB value is defined as follows:

$$HLB = 20 \times ( 1 - \frac{{M}_{1}}{M} )$$

where M₁: Molar mass of the hydrophobic (lipophilic) portion of the emulsifier molecules; and
M: Molar mass of the total molecules of the emulsifier.

As a rule, emulsifiers in the form of surfactants which form “oil-in-water” emulsions have an HLB value of 8 to 18, according to the invention an HLB value of 9 to 16 having proven to be particularly suitable for emulsifying relatively high volume fractions, e.g., of more than about 70 vol. %, of the disperse—hydrophobic or lipophilic—phase in the—electrically conductive, hydrophilic or lipophobic-continuous phase, and in this case forming a highly concentrated emulsion.

In addition, it is conceivable, for example, that the emulsion of the liquid electrolyte further contains at least one additive, in particular from the group of dyes, in order to make the (disperse/continuous) phases more visually recognizable, or optionally also the defoamer, for example.

In principle, any known granulate particles known for polishing or grinding metal workpieces, including those of the type mentioned above, can be considered as solid granulate particles for the electrolyte medium according to the invention. Granulate particles made of polymer materials have proven particularly advantageous here, which have a lower hardness than mineral and metal materials and in particular can have a rounded shape, preferably essentially spherical, and/or an average particle diameter between about 10 μm and about 5 mm, preferably between about 100 μm and about 1 mm. In this case, the polymer materials of the granulate particles should be acid-resistant in view of the usually acidic environment of the emulsion of the liquid electrolyte (see also below) and oxidation-resistant in view of the electrochemical polishing process. In an example, the solid granulate particles can also be selected from the group of ion-exchange polymers, which are basically any ion-exchange polymers, but preferably cationic ion-exchange polymers, which are able to absorb metal ions released during the electrochemical polishing of the metal workpieces. Examples of advantageous ion-exchange polymers include copolymers of styrene with sulfonated ethylstyrene and/or with sulfonated divinylbenzene, acrylic resins with acrylic acid and/or methacrylic acid units, and the like.

In addition, the solid granulate particles can be compact or porous and/or gel exchangers, as is often the case with the aforementioned polymer materials due to their manufacturing process. If porous granulate particles are used, which usually have residual water in the pores due to the manufacturing process, the residual water can mix with the (polar) continuous phase of the emulsion of the liquid electrolyte or dissolve therein practically without limit.

As already indicated, the liquid electrolyte, in an example, has a pH between about 1 and about 7, in particular between about 2 and about 7, preferably between about 3 and about 7; and/or an electrical conductivity between about 0.05 mS/cm and about 5 mS/cm, in particular between about 0.1 mS/cm and about 3 mS/cm, preferably between about 0.2 mS/cm and about 3 mS/cm; and/or a density between about 0.92 g/ml and about 1.04 g/ml, in particular between about 0.96 g/ml and about 1.00 g/ml.

Furthermore, the volume ratio between the solid granulate particles and the emulsion of the liquid electrolyte should be selected such that said electrolyte essentially completely fills the cavity volume of the granulate particles and a workpiece moving in the electrolyte medium relative to the granulate particles is essentially completely wetted by the emulsion of the liquid electrolyte. Thus, depending on the average particle diameter of the granulate particles, the volume ratio between the granulate particles and the emulsion of the liquid electrolyte can be, for example, between about 80 vol. % and 20 vol. % up to about 40 vol. % and 60 vol. %, in particular between about 75 vol. % and 25 vol. % up to about 45 vol. % and 65 vol. %.

In the method according to the invention for the electrochemical polishing of metal workpieces, according to which an electrolyte medium of the type described above is added to a container and electrically conductively connected to a cathode, the metal workpiece being electrically conductively connected to an anode and immersed in the electrolyte medium located in the container, the electrodes being subjected to an electrical voltage and the workpiece being moved relative to the plurality of solid granulate particles of the electrolyte medium, the relative movement of the metal workpiece with respect to the solid granulate particles can take place in any known manner, as is known, for example, in conventional drag or dip finishing methods. As far as such a relative movement of the workpiece in relation to the solid granulate particles during surface treatment is concerned, this can therefore be, for example: a rotational movement of the workpiece and/or the container, in particular essentially about an axis of symmetry of the workpiece and/or the container; and/or a translational movement of the workpiece in relation to the container, in particular essentially in the form of a trajectory; and/or a vibration excitation of the workpiece and/or the container, e.g., by means of ultrasound, piezo actuators, unbalance drives or the like.

Furthermore, in order to avoid damage to the workpieces by their impacting each other and/or the wall of the container, it can be advantageous if the metal workpiece is clamped to a workpiece holder that is movable relative to the container and which also allows easy electrical contacting of the (relevant) workpiece.

Furthermore, it can advantageously be provided that the emulsion of the electrolyte medium, in particular its continuous phase, is selected to be chemically and electrochemically inert with respect to the metal material of the workpiece to be electropolished.

The following examples of electrolyte media according to the invention, serve only for illustrative purposes and do not limit the invention:

### Example 1:

(a) Granulate particles: porous polymer particles with an average particle diameter of about 500 μm and/or about 1 mm made of ion-exchange resin based on copolymers of styrene and sulfonated ethylstyrene;
(b) Electrolyte:
Continuous phase (hydrophilic, electrically conductive):
   49% by mass of ethylene glycol and glycerol as polar solvents,
   11% by mass of benzenesulfonic acid, C10-C13-sec-alkyl derivatives as acid;
Disperse phase (hydrophobic, not electrically conductive):
   32% by mass of aliphatic hydrocarbon mixture in the form of C12 to C16 alkanes, isoalkanes and cycloalkanes;
Emulsifier (surfactant):
   7% by mass of alcohol ethoxylates, e.g., ethoxylated iso-tridecanol and secondary alcohol ethoxylates;
Additives:
   1% by mass of defoamer.

### Example 2:

(a) Granulate particles: porous polymer particles with an average particle diameter of about 500 μm and/or about 1 mm made of ion-exchange resin based on copolymers of styrene and sulfonated ethylstyrene;
(b) Electrolyte:
Continuous phase (hydrophilic, electrically conductive):
   19% by mass of ethylene glycol as polar solvent,
   10% by mass of alkylsulfonic acid, e.g., methanesulfonic acid, as acid;
Disperse phase (hydrophobic, not electrically conductive):
   61% by mass of aliphatic hydrocarbon mixture in the form of C12 to C16 alkanes, isoalkanes and cycloalkanes;
Emulsifier (surfactant):
   10% by mass of alcohol ethoxylates, e.g., ethoxylated iso-tridecanol.

### Example 3:

(a) Granulate particles: porous polymer particles with an average particle diameter of about 500 μm and/or about 1 mm made of ion-exchange resin based on copolymers of styrene and sulfonated ethylstyrene;
(b) Electrolyte:
Continuous phase (hydrophilic, electrically conductive):
   23% by mass of ethylene glycol and water as polar solvents;
   5% by mass of alkylsulfonic acid, e.g., C10 to C13 sulfonic acids, as acid;
   4% by mass of inorganic acid;
Disperse phase (hydrophobic, not electrically conductive):
   58% by mass of aliphatic hydrocarbon mixture in the form of C12 to C16 alkanes, isoalkanes and cycloalkanes;
Emulsifier (surfactant):
   10% by mass of alcohol ethoxylates, for example ethoxylated iso-tridecanol.

What is claimed is:

1. An electrolyte medium for electrochemical polishing of metal workpieces, the electrolyte medium comprising:
a plurality of solid granulate particles; and
a liquid electrolyte that comprises an emulsion with a continuous phase of at least one electrically conductive hydrophilic liquid and, emulsified herein, a disperse phase of at least one hydrophobic liquid which is immiscible with the electrically conductive hydrophilic liquid and is less electrically conductive by comparison.

2. The electrolyte medium according to claim 1, wherein the electrically conductive, hydrophilic liquid of the continuous phase of the emulsion contains at least one liquid from the group of polar organic solvents, in particular from the group of alcohols, and/or water.

3. The electrolyte medium according to claim 1, wherein the electrically conductive, hydrophilic liquid of the continuous phase of the emulsion further contains at least one acid.

4. The electrolyte medium according to claim 1, wherein the hydrophobic liquid of the disperse phase of the emulsion contains at least one liquid from the group of aliphatic, hydrocarbons, and/or silicone oils.

5. The electrolyte medium according to claim 1, wherein the proportion of the disperse phase of the emulsion is between 15% by mass and 70% by mass, or between 25% by mass and 60% by mass, based on the entire emulsion.

6. The electrolyte medium according to claim 1, wherein the emulsion further contains at least one emulsifier selected from the group of surfactants.

7. The electrolyte medium according to claim 6, wherein the emulsion contains at least one emulsifier from the group of alkoxylated alcohols having at least 8 carbon atoms, sulfonic acids having at least 8 carbon atoms, sulfonates and alaninates.

8. The electrolyte medium according to claim 6, wherein the HLB value of the at least one emulsifier is between 8 and 18, in particular between 9 and 16.

9. The electrolyte medium according to claim 1, wherein the solid granulate particles are made of polymer materials from the group of ion-exchanging polymers.

10. The electrolyte medium according to claim 1, wherein the solid granulate particles are porous and/or gel exchangers.

11. The electrolyte medium according to claim 1, wherein the liquid electrolyte has:
a pH value between 1 and 7 or between 2 and 7; and/or
an electrical conductivity between 0.05 mS/cm and 5 mS/cm or between 0.1 mS/cm and 3 mS/cm; and/or
a density between 0.92 g/ml and 1.04 g/ml, or between 0.96 g/ml and 1.00 g/ml.

12. A method for the electrochemical polishing of metal workpieces, the method comprising:
applying wherein the electrolyte medium according to claim 1 to a container and is electrically conductively connected to a cathode;
electrically conductively connecting the metal workpiece to an anode and immersing the metal workpiece in the electrolyte medium located in the container;
subjecting the electrodes to an electrical voltage; and
moving the workpiece relative to the plurality of solid granulate particles of the electrolyte medium.

13. The method according to claim 12, wherein the relative movement of the metal workpiece with respect to the electrolyte medium located in the container is achieved by at least one relative movement from the group of:
rotational movement of the workpiece and/or the container substantially about an axis of symmetry of the workpiece and/or the container;
translational movement of the workpiece in relation to the container; and/or
vibration excitation of the workpiece and/or the container.

14. The method according to claim 12, wherein the metal workpiece is clamped to a workpiece holder which is movable relative to the container.

15. The method according to claim 12, wherein the emulsion of the electrolyte medium, in particular its continuous phase, is selected to be chemically and electrochemically inert with respect to the metal material of the workpiece to be electropolished.
